(19) United States
(12) Patent Application Publication
(10) Pub. No.: US 2008/0217255 A1
(43) Pub. Date: Sep. 11, 2008

(54) Methods for Filtering a Fluid and an Apparatus and Filter Apparatus for Performing Said Method

(76) Inventor: Harald Pohl, Horstel (DE)

Correspondence Address: DENNISON, SCHULTZ & MACDONALD, 1727 KING STREET, SUITE 105, ALEXANDRIA, VA, 22314, US

(21) Appl. No.: 10/558,647

(22) PCT Filed: Aug. 8, 2005
(86) PCT No.: PCT/DE05/01400

§ 371 Date: Mar. 7, 2006

(30) Foreign Application Priority Data
Aug. 19, 2004 (DE) 10 2004 040 389.9

(51) Int. Cl. C02F 1/00

(52) U.S. Cl. 210/739; 210/767

(57) ABSTRACT

Two methods for filtering a fluid, an apparatus and a filter apparatus for performing the method are described. The fluid to be filtered is passed through at least one filter, where the flow of fluid is throttled. At least one actual value of a working parameter of the fluid is measured; this actual value is compared with a predetermined set value and at least one actuating variable is generated as a function of at least one actual value-set deviation. The degree of throttling is then varied as a function of this actuating variable.

The present invention relates to a first method for filtering a fluid, in particular for filtering a polymer melt, having the features of the preamble of patent claim 1, a second method for filtering a fluid, in particular for filtering a polymer melt, having the features of the preamble of patent claim 2, an apparatus for performing this method having the features of the preamble of the patent claim 8 and a filter apparatus for performing the method having the features of the preamble of patent claim 25.

It is known that to process fluids, in particular polymer melts, these fluids, i.e., polymer melts, must be filtered. To do so, a stream of the fluid under pressure is passed continuously through a filter, so that the fluid filtered in this way can be supplied to a tool accordingly. For example, from the extensive prior art, reference is made here only to German Patent DE 44 08 803, German Patent DE 196 12 790 and German Patent DE 195 19 519. Like the present patent application, these patents preferably describe the filtration of polymer melts.

With the known methods, the pressure prevailing upstream from the filter increases steadily with progressive soiling of the filter, so that on reaching a limit value for the pressure, which is not usually measured, a filter change must be performed, either continuously or discontinuously. This filter change is usually performed according to empirically determined sequences, whereby in the case of a continuous filter change, the filtration process is not interrupted, whereas in a discontinuous filter change, there must be an interruption in operation for replacement and/or cleaning of the filter.

The methods known previously have the disadvantage that the fluid to be filtered is subject to cyclic pressure fluctuations, consisting of a first partial cycle in which the pressure is increased caused by the increasing soiling of the filter, optionally a second partial cycle, which is usually quite short and during which the pressure is further increased, caused by the replacement and/or cleaning of the filter, and a third partial cycle, whereby a pressure level upstream from the filter corresponding to the initial pressure level of the first partial cycle is reached at the start of this third partial cycle. This initial pressure level of the third partial cycle comes about due to the fact that a fresh filter, i.e., a filter having no load because of the cleaning of the filter or replacement thereof, is then available again for further filtration, and then this unsoiled filter becomes loaded again with dirt while performing the further filtration process, as already described for the first partial cycle.

The cyclic fluctuations in pressure described above upstream from the filter can lead to unwanted changes in the system being filtered, depending on the fluid to be filtered in each case and depending in particular on the polymer melt to be filtered in each case. Unwanted production defects may occur when working with sensitive polymer melts in particular, i.e., melts which undergo changes in their chemical and/or physical properties, depending on the prevailing pressure.

The object of the present invention is to make available a first method, a second method, an apparatus and a filter apparatus for implementing the method to permit an especially gentle filtration of a fluid, in particular an especially gentle filtration of a polymer melt.

This object is achieved by a first method having the characterizing features of patent claim 1, by a second method having the characterizing features of patent claim 2, by an apparatus having the characterizing features of patent claim 8 and by a filter device having the characterizing features of patent claim 25.

According to the inventive method for filtering a fluid, in particular for filtering a polymer melt, a stream of the fluid under pressure is passed continuously through at least one filter and the fluid thereby filtered is subsequently sent to a tool (die-casting mold), as is also the case in the state of the art cited in the beginning. However, in deviation from this state of the art, in the first inventive method, the stream of fluid that has been filtered and/or is to be filtered is throttled, and at least one actual value of a working parameter of the fluid is measured. In addition, in the inventive method the actual value is compared with a predetermined, i.e., an adjustable, set value so that at least one actuating variable is generated as a function of at least one set-actual value deviation. Depending on this actuating variable, the degree of throttling is then varied in the inventive method. In other words, the first inventive method is thus based on the fact that at least one throttle is arranged in the fluid stream, optionally being positioned upstream from the filter, downstream from the filter or both upstream and downstream from the filter in the fluid flow, while on the other hand, the degree of throttling is controlled, whereby the actual value of a working parameter of the fluid is measured for this control method, and this measured actual value of the fluid is compared with a predetermined set value, so that then in the event of a set-actual value deviation, the actuating variable necessary for the control is generated, so that the degree of opening of the throttle is varied accordingly.

The inventive method has a number of advantages. First, it should be pointed out that due to the inventive method the point in time of changing the filter is not determined empirically, as is the case with the known method, but instead this point in time is determined accurately on the basis of measured values that are obtained. This makes it possible for filtering of the fluid which is performed by the inventive method to be done in a particularly reproducible manner so that the inventive apparatus respectively device accordingly can be operated with reduced personnel costs without resulting in unwanted downtime. Due to the fact that with the inventive method there is also a throttle generating a backpressure in addition to the at least one filter which becomes progressively loaded with dirt in the course of its use, resulting in changes in the pressure of the filter in the fluid to be filtered upstream from the filter, the degree of opening of the throttle and thus the backpressure generated by it being variable and adjustable in particular, therefore with the inventive method, the increasing pressure upstream from the filter caused by the progressive soiling of the filter can be compensated by an increase in the degree of opening of the throttle, so the inventive method permits filtration of the fluid at a constant pressure while maintaining a uniform flow rate of filtered fluid per unit of time to the tool and/or maintaining a constant temperature and/or a constant viscosity. The inventive method here allows this constant pressure to prevail upstream from the filter in particular, thereby preventing unwanted changes in chemical and/or physical properties of the polymer melt, especially in the case of pressure-sensitive polymer melts. This constant pressure, which prevails in particular upstream from the filter in the inventive method, also protects the means positioned there for creating the stream of liquid under pressure, preferably an extruder, a corresponding pump or a supply of fluid under pressure. In addition, the constant pressure provided in the inventive method also makes it possible to drain off the gases that are contained in the fluid to be filtered and must be removed before the filtration process at one and the same location upstream from the filter, which is not the case with the known method because of the pressure cycles described above. In this way, the fluid to be filtered, preferably a polymer melt, is optimally degassed, which has a very positive influence on the quality of the workpiece created by the tool, so that by using the inventive method not only is it possible to produce improved workpieces (extrudates) but also the incidence of defective workpieces can be reduced.

It should be pointed out in clarification that the term “fluid” as used in the present patent application refers in particular to a polymer melt. Preferred examples of such polymer melts include plastics such as polypropylene, polyethylene, high-pressure polyethylene, low-pressure polyethylene, linear low-pressure polyethylene, poly-styrene, polyamide, alkyl-butadiene-styrene (ABS), poly-ester, polyoxymethylene (POM), polyacrylates, especially polymethyl-methacrylates (PMMA) and polyvinyl chloride. It should also be pointed out in clarification that all terms used in the singular, e.g., “filter” in the present application, should be understood to include not only the single item, e.g., a single filter, but also any number of these items, e.g., any number of filters. It should also be pointed out that all terms linked by “and/or” should be interpreted both additively and alternatively, and this statement is true even if only the last two terms are linked with “and/or” in a list of more than two terms, so that in this type of list, all terms or only some of the terms are to be linked together additively or alternatively. The terms “upstream” and “downstream” are always to be understood as referring to the direction of flow of the fluid to be filtered.

According to a fundamental second inventive method for filtering a fluid, in particular for filtering a polymer melt, a stream of fluid under pressure is passed continuously through at least one filter and then the fluid thereby filtered is supplied to a tool. As in the first inventive method described above, the stream of fluid that is to be and/or has been filtered is also throttled in the second inventive method, but in the second inventive method, the actual value of the degree of throttling is adjusted to a predetermined value. In addition, in this second inventive method, an actual value of a working parameter of the fluid is measured and the actual value of the degree of throttling is varied until the aforementioned actual value of the working parameter of the fluid has an inputable and constant set value. This second inventive method like the first inventive method fulfills the object as formulated above and has all the advantages already described for the first inventive method. This second inventive method differs from the first inventive method in that the degree of throttling is preselected, an actual value of a parameter of the fluid is measured, and the actual value of the degree of throttling is varied until the actual value of the working parameter of the fluid has assumed an inputable and constant set value, so this second inventive method also permits reproducible filtration of the fluid at a constant pressure.

In other words, in the second inventive method described above, the degree of throttling is adjusted and varied until the actual value of the working parameter has assumed a constant inputable set value, and this adjustment is made repeatedly in the course of the filtration process with increasing soiling of the filter and is adjusted accordingly.

With regard to the actual value of the working parameter of the fluid, which is to be measured in the inventive method, it should be pointed out in general that any measurement method and thus any measured value which also changes with a change in the degree of soiling of the filter is suitable for this purpose. In particular with the inventive method, the pressure, the flow quantity, the flow rate, the temperature and/or viscosity of the fluid that is to be and/or has been filtered are measured as the actual value of the working parameter of the fluid in the inventive method.

As already discussed at the beginning with regard to the inventive method, the stream of fluid is throttled in the inventive method as a function of the degree of soiling of the filter and/or the number of filters available for filtration, where the degree of throttling, i.e., the amount of throttling, to speak in general terms, depends on how the measured actual value of a working parameter of the fluid changes with respect to an adjustable set value of the fluid.

If a heavily soiled fluid, e.g., a polymer melt of a recycled material, is to be filtered by the inventive method, then it is advisable to use an embodiment of the inventive method in which the stream of filtered fluid is throttled. This embodiment of the inventive method has the advantage that the throttle, which is then situated downstream from the filter, cannot become soiled so easily that the throttle element in this regard comes in contact only with filtered fluid.

However, if the fluid to be filtered has only a low degree of soiling, then according to another embodiment of the inventive method, the throttle is arranged upstream from the filter, so that the stream of fluid to be filtered is throttled accordingly.

According to an embodiment of the inventive method that is especially suitable and can be implemented without problems, the pressure of the fluid to be filtered in this embodiment is measured as the actual value of a working parameter of the fluid, so that on exceeding a predetermined pressure value, which is referred to as the set value in the sense described above, the degree of throttling is reduced, and when the pressure value drops below a predetermined level, the degree of throttling is increased. In other words, in this preferred embodiment, the degree of throttling is varied as a function of the pressure prevailing upstream from the filter, such that at the start of filtration, when the filter has little or no burden of dirt and the pressure assumes a relatively low level accordingly, the throttling is great. As the soiling of the filter, which leads to an increase in pressure upstream from the filter, the degree of throttling is reduced, which means simply that the throttle is opened more and the pressure drops and is kept at a constant pressure level. In the final stage of this mode of operation in which the filter is heavily soiled and replacement or cleaning of the filter is necessary, the degree of throttling is then reduced to such an extent that the throttle has little or no influence on the fluid stream. Then when an unsoiled filter is again available, the degree of throttling is increased, so that at this point in time, the constant initial pressure prevailing over the entire cycle then prevails again upstream from the filter. By adjusting the varying degree of soiling of the filter and the degree of opening of the throttle, this embodiment of the inventive method thus achieves the result that a constant pressure, which varies only within certain pressure fluctuations, always prevails upstream from the filter and this is accomplished in an especially simple and advantageous manner. At the same time, this ensures that the tool situated downstream from the filter is supplied with a volume flow or mass flow of filtered fluid that remains uniform over time.

In another refinement of the special embodiment of the inventive method described above, not only the pressure of the fluid upstream from the filter but also the pressure of the fluid downstream from the throttle are measured. A signal for performing a filter change is also generated when a predetermined pressure difference is exceeded. This filter change, which is equivalent to an actual replacement or cleaning of the filter, can be performed either manually or automatically. In the first case, a visual or acoustic signal preferably indicates the need for such a filter change. The special advantage of this embodiment of the inventive method can be regarded as the fact that this not only permits filtration at a constant pressure as described above but also at the same time indicates when a manual or automatic filter change is necessary. By employing this special embodiment of the inventive method, it is thus possible to eliminate substantial personnel capacity and to accurately quantify the point in time for a filter change.

In addition, the present invention relates to an apparatus for performing the inventive method described above.

The inventive apparatus has means, in particular an extruder, for producing a continuous stream of a fluid under pressure, in particular a polymer melt. Following this, as seen in the direction of flow of the fluid to be filtered, there is a filter device having at least one filter for filtering the fluid, so that the fluid is filtered through this filter device. This filter device is followed in the inventive apparatus by at least one tool. In addition, in the case of the inventive apparatus, a detection unit for the actual value of a working parameter of the fluid is assigned to the area upstream and/or downstream from the filter device, whereby a throttle is also provided upstream and/or downstream from the filter device in the stream of the fluid. The detection unit generates an actuating variable for varying the degree of opening of the throttle when there is a deviation in the actual value of the working parameter of the fluid from a predetermined, i.e. adjustable set value of the working parameter of the fluid, such that the degree of opening of the throttle is increased continuously with progressive soiling of the at least one filter. In other words, the inventive apparatus differs essentially from the known devices in that with the inventive apparatus a throttle is arranged in the flow path of the fluid whose degree of opening is varied as a function of a value detected and compared with a predetermined value of the fluid such that the degree of opening of the throttle is increased with progressive soiling of the filter, whereas at the start of filtration, i.e., at a point in time when the filter is not yet soiled, the degree of opening of the throttle is slight, so that this throttle presents a suitable resistance to the fluid flow accordingly. The inventive apparatus of course also ensures that over the entire period of time, regardless of the degree of soiling of the filter and the degree of opening of the throttle, a fluid quantity that is constant per unit of time is supplied to the tool, which is provided downstream from the filter apparatus.

The inventive apparatus has all the advantages described above for the inventive method. Here again, it is also found that in the case of the inventive apparatus the point in time of filter changing is not defined empirically, as is the case with the known devices, but instead this point in time is determined accurately on the basis of actual measured values. Therefore, not only is the filtration of the fluid which is to be performed with the inventive apparatus designed to be especially reproducible, but also the inventive apparatus can be operated with reduced personnel without any unwanted downtime or interruptions. In addition to the filter, which becomes progressively soiled during the course of its use, so that there are changes in the pressure upstream from the filter in the fluid to be filtered, a throttle is also provided in the apparatus according to the present invention to create a backpressure, the degree of opening and thus also the backpressure being variable, in particular adjustable. Therefore, the rising pressure upstream from the filter in the apparatus according to the present invention can be compensated by increasing the degree of opening of the throttle, so that the inventive device permits filtration of the fluid at a constant pressure while retaining a uniform volume flow of filtered fluid to the tool per unit of time. The inventive apparatus in particular allows this constant pressure to prevail upstream from the filter, so that preferably in the case of pressure-sensitive polymer melts, unwanted chemical and/or physical changes in properties of the polymer melts are prevented. This pressure constancy, which preferably prevails upstream from the filter in the apparatus according to the present invention, also protects the devices means positioned there for generating the stream of fluid under pressure, said means being in particular an extruder, a corresponding pump or a fluid supply under pressure. Furthermore, the pressure constancy prevailing with the apparatus according to the present invention often allows removal and venting of the gases that are present in the fluid that is to be filtered at one and the same location upstream from the filter before the filtration process, which was impossible with the known devices or could be done so only at great expense and complexity because of the pressure cycles described previously. In this way, the fluid to be filtered, preferably a polymer melt, is therefore optimally degassed, which has a considerable positive influence on the quality of the workpiece produced by the tool so that not only improved workpieces can be manufactured by using the apparatus according to the present invention but also the incidence of defective workpieces can be reduced.

As already explained above with regard to the inventive method, the detection unit with the inventive apparatus is designed so that the detection unit detects as an actual value of the working parameter of the fluid a measured value which also changes with a change in the degree of soiling of the filter. In particular, the detection unit provided with the inventive apparatus is designed so that it detects the pressure, the flow quantity, the flow rate, the temperature and/or the viscosity of the fluid as actual values of the working parameter of the fluid.

According to a preferred embodiment of the inventive apparatus, the detection unit has a pressure sensor for detecting the fluid pressure upstream or downstream or upstream and downstream from the filter device, whereby a pressure is measured in the first of the two cases just mentioned in which the fluid pressure is detected upstream or downstream from the filter device and in the latter case (upstream and downstream) a differential pressure is measured. Furthermore, the detection unit is designed so that the actual value of the pressure which is detected as a working parameter of the fluid or the actual value of the pressure difference is compared with the predetermined, i.e., adjustable pressure set value, i.e., differential pressure set value; and as soon as the actual value exceeds the set value, an actuating variable is generated, thus causing an increase in the degree of opening of the throttle. This embodiment of the inventive apparatus has the important advantage that the pressure upstream from the filter device in particular can be kept constant in this way in an especially simple and reproducible manner, whereby as an additional advantage of this embodiment of the inventive apparatus it should be pointed out that the pressure sensors provided here are inexpensive and are characterized by a low maintenance and trouble-free operation.

Another embodiment of the inventive apparatus has a detection unit which is provided with at least one temperature sensor for detecting the fluid temperature upstream and/or downstream from the filter device or for detecting a temperature difference. The resulting actual value of the temperature of the fluid and/or the differential temperature actual value is compared in the detection unit with the predetermined temperature set value and/or predetermined temperature difference set value so that as soon as the actual value exceeds the set value, an actuating variable is generated by the detection unit, causing the degree of opening of the throttle to increase. This embodiment of the inventive apparatus is preferably used when a thin fluid polymer melt is to be filtered with the inventive device.

According to an especially advantageous refinement of the inventive apparatus, the throttle is arranged upstream from the filter device. This embodiment is always preferred when the fluid to be filtered has only a relatively low degree of contamination, so there is no risk here of the functionality of the throttle being impaired due to deposited dirt particles.

In a refinement of the embodiment of the inventive apparatus described previously, the throttle situated upstream from the filter device is provided with a valve or this valve is designed in one piece with the throttle, whereby this valve in its opened position discharges a fluid stream toward the atmosphere. This embodiment of the inventive apparatus is always preferred for use when the fluid to be filtered, in particular the polymer melt to be filtered, has a tendency to form particulate agglomerates during even a short downtime. These particulate agglomerates can then be discharged from the inventive apparatus at the start of filtration, so that these agglomerates do not cause soiling of the filter at the start of filtration.

According to another embodiment of the inventive apparatus, the throttle is situated downstream from the filter device. This embodiment of the inventive apparatus is always used when the fluid to be filtered is highly contaminated. The advantage of such an arrangement of the throttle can be regarded as the fact that the throttle provided downstream from the filter device does not come in contact with contaminated fluid. In addition, this embodiment of the inventive apparatus is characterized by a high operating reliability, so it is preferably also used for filtration of a recycled melt of polymer material.

An especially fine coordination of the degree of throttling of the fluid stream is achieved with the inventive apparatus due to the fact that a throttle is provided upstream and downstream from the filter device. In particular when the throttle provided upstream from the filter device is provided with the valve described previously, or the valve described previously is assigned to this throttle, highly contaminated polymer melts, less contaminated polymer melts and even those polymer melts that have a tendency to form fixed agglomerates can be filtered with such an embodiment of the inventive apparatus, so that with heavily contaminated polymer melts preferably only the throttle installed downstream from the filter device is used, and when there is a less contaminated melt both throttles are used jointly or individually one throttle is used, depending on the particular contamination of the polymer melt to be filtered and/or the properties of the melt; and in addition, the throttle arranged upstream from the filter device may also be used to remove the agglomerates at the start of filtration. This embodiment of the inventive apparatus can thus be used universally and can be adapted very easily to the particular requirements.

With regard to the throttle provided in the fluid stream in the inventive apparatus, it should be pointed out in general that this throttle is designed so that its degree of opening can be varied within narrow limits and furthermore the throttle are designed so that dead spaces are minimized.

An embodiment of the inventive apparatus that is particularly resistant to trouble has a throttle which equipped with a receiving space through which the fluid flows. This receiving space is preferably a pipe section through which fluid flows, whereby this receiving space has a throttle element penetrating into the fluid. The throttle element here can be moved between a first position in which the fluid stream is almost interrupted, so that there is only a small degree of opening of the throttle, and a second position in which the throttle element causes little or no hindrance to the fluid stream, so that in this case there is a high degree of opening of the throttle and vice versa. In the simplest case in this embodiment of this inventive apparatus, the throttle element is designed as a flat slide valve and is assigned to a pipe section through which the fluid flows so that the degree of opening of the throttle is adjustable by a movement of this flat slide valve.

According to another refinement of the embodiment of the inventive device described above, a throttle is provided in which the throttle element is designed as a cylindrical throttle plunger and the receiving space is designed as a cylindrical receiving space, whereby the stream of fluid is passed through this cylindrical receiving space. The cylindrical throttle plunger is mounted in the cylindrical receiving space, so that it is displaceable axially between the first position described above and the second position so that the degree of opening of the throttle can be varied can be varied as desired by an axial displacement of the cylindrical throttle element. Instead of the cylindrical receiving space, a pipe section through which the fluid is guided may also serve as a receiving space, where this pipe section has a suitably shaped housing area to guide and hold the cylindrical throttle element. In the case of an axial displacement of the cylindrical throttle element, the diameter of which is larger than the cross section of the pipe section, the throttle element then penetrates into the receiving space which is designed as a pipe section and, depending on its depth of penetration, achieves the desired throttling of the fluid flow. However, as an alternative to this, a cylindrical throttle element equipped with a passage corresponding to the cross section of the pipe section, preferably a cylindrical through-bore, may also be used, whereby this throttle is mounted in a housing section, so that through an axial displacement of the cylindrical throttle element, the through-opening provided in the cylindrical throttle element is more or less aligned with the inside wall of the pipe, so that the degree of opening of the throttle can be adjusted especially easily and accurately.

According to another embodiment of the inventive apparatus, it has a specially shaped throttle, whereby this throttle is characterized in that it completely prevents dead zones in the flow. To achieve this, the throttle has a receiving space which is designed with a conical shape, whereby inside this receiving shape there is a throttle element which is also designed with a conical shape adapted to the former. The conical throttle element here is axially displaceable between the first position and the second position, whereby a fluid feed partial channel is arranged upstream from the throttle element and assigned to the receiving space and a fluid discharge partial channel is provided downstream from the throttle element. The stream of fluid into the receiving space is led through the fluid feed partial channel and the stream of fluid is removed from the receiving space through the fluid discharge partial channel. Owing to the conicity of the receiving space and the throttle element, this design of the throttle allows a very fine setting of the degree of the opening of the throttle whereby at the same time the conical walls of the receiving space and the throttle prevent unwanted deposits of fluid residues.

The advantages mentioned above are achieved to a particularly great extent by a throttle having this design, in particular when in the embodiment of the inventive device described above, which has a special throttle, the fluid discharge partial channel has a first section, as seen in the direction of flow of the fluid, running outside of the receiving space on both sides of the housing of the receiving space and opening into the fluid discharge partial channel.

In particular the first section of the fluid discharge partial channel in the direction of flow of the fluid is designed as a ring channel, where the ring channel completely or partially surrounds the housing of the receiving space from the outside, as explained in greater detail below on the basis of a concrete embodiment.

To achieve the desired throttling of the fluid flow with the inventive apparatus as a function of the prevailing load on the filter, it is advisable for the throttle element of the embodiment described previously to be moved as a function of the actuating variable generated by the detection unit. This movement, which preferably represents an axial displacement of the throttle element, may be performed either manually or preferably automatically, in which case a drive for the axial movement of the throttle element is provided for the throttle element for this purpose. This drive is designed as a hydraulic, pneumatic or electric drive in particular.

According to a refinement of the embodiment of the inventive apparatus described previously, the throttle element moves only over a predetermined dimension and is preferably displaced axially. This predetermined dimension is between the first and second positions of the throttle element, so that the degree of opening of the throttle is increased or reduced accordingly. When this predetermined dimension is exceeded, a visual and/or acoustic signal is generated so that occurrence of this signal indicates to the operating person that a filter change is necessary.

According to another variant of the embodiment of the inventive apparatus described above, when the predetermined quantity is exceeded, backwashing of the soiled filter is triggered automatically. However, this embodiment of the inventive apparatus requires at least two filters, whereby these two filters can be optionally moved between a first position in which they both filter the fluid stream and a second position in which one filter is filtering the fluid stream while the other filter is being backwashed with a substream of filtered fluid in the opposite direction from the direction of flow in filtration. During this backwashing process, the partial stream of filtered fluid then releases the accumulated soiling on the filter surface and carries it away in the opposite direction from the direction of flow of the fluid in filtration, discharging it to the atmosphere through a suitable valve upstream from the filter device, so that after the end of this backwashing process, a filter freed of dirt particles is made available again for renewed filtration.

The inventive apparatus may essentially have any of the known filter devices, whereby the band filters described in the state of the art can be mentioned here as examples. However, it is especially suitable if the inventive apparatus comprises a filter device which has at least two filters arranged with an axial distance between them inside a bolt that is mounted in a housing and is displaceable axially thereto. Optionally then the fluid to be filtered may pass through the at least two filters or at least one filter, while at the same time the at least one other filter is in a position outside of the filter apparatus so that this one filter outside of the filter apparatus can be changed manually by the operating personnel and cleaned or replaced by a new filter.

Another embodiment of the inventive apparatus which is also advantageous comprises a filter device which has two bolts arranged inside a housing, so that they are axially displaceable thereto, each bolt being provided with at least two filters arranged with an axial distance between them. These bolts are mounted so they are displaceable axially with a fluid-tight seal in suitable housing bores, whereby the fluid to be filtered flows through all the filters, or at least one filter is in a position outside of the filter apparatus while the fluid to be filtered is flowing through the other remaining filters. This achieves the result that one or more filters which are in a position outside of the filter apparatus can be replaced or cleaned without interrupting the filtration process and without resulting in unwanted pressure fluctuations.

The present invention also relates to a filter apparatus for performing the inventive method.

The inventive filter apparatus has a first connecting element for connecting the filter apparatus to means, in particular to an extruder, for generating a continuous stream of a fluid under pressure, in particular a polymer melt. In addition, a second connecting element is provided, connecting the inventive filter apparatus to a tool, whereby the inventive filter apparatus comprises at least one filter through which fluid flows. In addition, with the inventive filter apparatus, a detection unit for detecting the actual value of a working parameter of the fluid is arranged between the first connecting element and the filter and/or between the filter and the second connecting element, whereby a throttle is provided upstream and/or downstream from the filter apparatus, i.e., between the first connecting element and the filter and/or between the filter and the second connecting element, also in the stream of the fluid. When there is a deviation in the actual value of the working parameter of the fluid from a predetermined, i.e., adjustable, set value of the working parameter of the fluid, the detection unit generates an actuating variable for varying the degree of opening of the throttle, such that with an increase in the soiling of the at least one filter, the degree of opening of the throttle is increased continuously. In other words, the inventive filter apparatus differs essentially from the known devices in that with the inventive filter apparatus a throttle is situated upstream and/or downstream from the filter in the path of flow of the fluid, the degree of opening of this throttle device being varied as a function of a value detected and compared with a predetermined value of the fluid such that the degree of opening of the throttle is increased with increasing soiling of the filter whereas at the start of filtration, i.e., at a point in time when the filter is not yet soiled, the degree of opening of the throttle is low so that this throttle presents a corresponding resistance (backpressure) to the fluid flow accordingly. The inventive filter apparatus ensures of course that a constant amount of fluid per unit of time is supplied to the tool downstream from the filter apparatus over the entire period of time regardless of the degree of soiling of the filter or the degree of opening of the throttle.

The inventive filter apparatus has all the advantages described above for the inventive method and the inventive apparatus. Thus here again it should be pointed out that with the inventive filter apparatus, the point in time of replacing the filter is not set empirically, as is the case with the known devices, but instead this point in time is determined accurately on the basis of the measured values detected. This makes not only the filtration of the fluid which is to be performed by means of the inventive filter apparatus especially reproducible but also the inventive filter apparatus can be operated with less personnel is required to operate it without any unwanted downtime or interruptions in operation. Due to the fact that with the filter apparatus according to this invention, a throttle which creates a backpressure is provided in addition to the filter which becomes increasingly loaded with dirt in the course of its use, so that the pressure upstream from the filter changes in the fluid to be filtered, and the degree of opening of the throttle and thus also its backpressure can be varied and adjusted in particular, therefore with the inventive filter apparatus the rising pressure upstream from the filter can be compensated by increasing the degree of opening of the throttle so that the inventive filter apparatus permits filtration of the fluid at a constant pressure while retaining a uniform volume flow of filtered fluid per unit of time to the tool. The inventive filter apparatus here allows in particular this constant pressure to prevail upstream from the filter so that especially in the case of polymer melts that are sensitive to pressure, unwanted changes in chemical and/or physical properties of the polymer melt are prevented. This constant pressure which preferably prevails upstream from the filter with the inventive filter apparatus protects the means installed there for creating the stream of fluid under pressure, in particular an extruder, a corresponding pump or a fluid supply under pressure. Furthermore, the constant pressure prevailing with the inventive filter apparatus has the effect that the gases which are frequently present in the fluid to be filtered and must be removed prior to the filtration process can be vented at one and the same location upstream from the filter, which is impossible with the known devices because of the pressure cycles described above or it can be accomplished only with great complexity. In this way, the fluid to be filtered, preferably a polymer melt, is optimally degassed, which has a strongly positive influence on the quality of the workpiece produced by the tool, so that the inventive filter apparatus not only makes it possible to produce improved workpieces but also reduces the incidence of defective workpieces. Owing to the compactness of the inventive filter apparatus, it can be installed in any traditional fluid filtration system in the sense of a retrofitting kit.

As already explained in the introductory discussion of the inventive method, the detection unit with the inventive filter apparatus is designed so that the detection unit detects as the actual value of the working parameter of the fluid a measured value which also varies with a change in the degree of soiling of the filter. In particular, the detection unit provided with the inventive filter apparatus is designed so that it detects as the actual value of the working parameter of the fluid the pressure, the flow quantity, the flow rate, the temperature and/or the viscosity of the fluid.

According to a preferred embodiment of the inventive filter apparatus, the detection unit assigned to the filter apparatus has a pressure sensor for detecting the fluid pressure upstream or downstream or upstream and downstream from the filter apparatus, whereby in the two former cases in which the fluid pressure is detected upstream or downstream from the filter apparatus, a pressure is measured whereas in the latter case (upstream and downstream) a pressure difference is measured. In addition, the detection unit is designed so that the actual value of the pressure or the pressure difference detected as the working parameter of the fluid is compared with the predetermined, i.e., adjustable, pressure set value and/or pressure difference set value and as soon as the actual value exceeds the set value, an actuating variable is generated which causes the degree of opening of the throttle to be increased. This embodiment of the inventive filter apparatus has the significant advantage that it makes it possible to keep the pressure in particular upstream from the filter apparatus constant in a particularly simply and reproducible manner, whereby as the additional advantage of this embodiment of the inventive filter apparatus, it should be pointed out that the pressure sensors proposed here are inexpensive and are characterized by a low-maintenance and trouble-free operation.

Another embodiment of the inventive filter apparatus has such a detection unit which is provided with at least one temperature sensor for detecting the fluid temperature upstream and/or downstream from the filter device or for detecting a temperature difference. The actual temperature value of the fluid thereby detected and/or the actual value of the temperature difference is compared in the detection unit with the predetermined temperature set value and/or predetermined temperature difference set value so that as soon as the actual value exceeds the set value, an actuating variable is generated by the detection unit, causing the degree of opening of the throttle to increase. This embodiment of the inventive filter apparatus is preferably used when a polymer melt having a low viscosity is to be filtered using the inventive filter apparatus.

According to an especially advantageous refinement of the inventive filter apparatus, the throttle is arranged upstream from the filter apparatus between the first connecting element and the filter. This embodiment is always preferred when the fluid to be filtered has only a relatively low degree of soiling so that there is no risk of impairing the functionality of the throttle due to deposited dirt particles.

In the refinement of the embodiment of the inventive filter apparatus described previously, the throttle situated upstream from the filter device is provided with a valve or this valve is designed in one piece with the throttle, whereby this valve vents a fluid stream toward the atmosphere when it is opened. This embodiment of the inventive filter apparatus is always preferred whenever the fluid to be filtered, in particular the polymer melt to be filtered, has a tendency to form particulate agglomerates with even short downtimes. These particulate agglomerates can then be removed by means of the valve at the beginning of filtration of the fluid so that these agglomerates do not already cause soiling of the filter.

According to another embodiment of the inventive filter apparatus, the throttle is arranged downstream from the filter device. This embodiment of the inventive filter apparatus is always used whenever the fluid to be filtered is highly contaminated, in which case the additional advantage of such an arrangement of the throttle may be seen as the fact that the throttle which is provided downstream from the filter device does not come in contact with the contaminated fluid. In addition, this embodiment of the inventive filter apparatus is characterized by a high operating reliability so that it is preferably also used for filtration of melts of recycled polymer materials.

An especially fine tuning of the degree of throttling of the fluid stream is achieved with the inventive filter apparatus due to the fact that one throttle is provided upstream from the filter and another throttle is provided downstream from the filter. In particular when the throttle situated upstream from the filter is provided with the valve described above or the valve described above is provided for this throttle, then such an embodiment of the inventive filter apparatus may be used to filter highly contaminated polymer melts, less contaminated polymer melts and even those melts which have a tendency to develop solid agglomerates so that, depending on the degree of soiling of the polymer melt to be filtered and/or its properties in each case, preferably only the throttle arranged downstream from the filter is used when the polymer melt is highly contaminated or both throttles are used together when the melt is less contaminated or an individual throttle is used, whereas in the case of melts that tend to form agglomerates, the throttle situated upstream from the filter may additionally be used to remove the agglomerates at the start of a filtration run. Therefore this embodiment and the inventive filtration device have universal applicability and can be adapted very easily to the prevailing requirements.

It should be pointed out by way of clarification that the term “upstream from the filter” denotes a position situated between the first connecting element and the filter, and the term “downstream from the filter” denotes a position situated between the filter and the second connecting element.

With regard to the throttle provided in the fluid stream in the inventive filter apparatus, it should be pointed out in general that this throttle is designed so that its degree of opening can be varied within narrow limits and furthermore the throttle is designed so as to minimize dead space.

An embodiment of the inventive filter apparatus that is especially trouble-free has a throttle which is provided with a receiving space through which the fluid flow passes. This receiving space is preferably a pipe section through which the fluid flows, whereby this receiving space has a throttle element penetrating into the fluid. The throttle element here is movable between a first position, in which the fluid stream is almost interrupted so that there is a small degree of opening of the throttle, and a second position in which the fluid stream there is little or no restriction in the fluid stream by the throttle element, so that this is associated with a high degree of opening of the throttle and vice versa. In the simplest case, in this embodiment of the inventive filter apparatus, the throttle element is designed as a flat slide valve and is provided for a pipe section through which the fluid flows, so that the degree of opening of the throttle is adjustable by a movement of this flat slide valve.

According to another refinement of the embodiment of the inventive filter apparatus described previously, the throttle element of the throttle is designed as a cylindrical throttle plunger and the receiving space is designed as a cylindrical receiving space, whereby the stream of fluid is passed through this cylindrical receiving space. The cylindrical throttle plunger is mounted so that it is displaceable axially in the cylindrical receiving space between the first position described previously and the second position so that through an axial displacement of the cylindrical throttle element, the degree of opening of the throttle is variable as desired. Instead of the cylindrical receiving space, a pipe section through which the fluid is passed may also serve as the receiving space, in which case this pipe section will have a suitably shaped housing area for guiding and holding the cylindrical throttle element. In the case of an axial displacement of the cylindrical throttle element whose diameter is larger than the diameter of the cross section of the pipe section, the throttle element then penetrates into the receiving space which is designed as a pipe section and then, depending on its depth of penetration, causes the desired throttling of the fluid stream. As an alternative to this, however, it is also possible to use a cylindrical throttle element which is equipped with a through-opening, preferably a cylindrical through-bore, corresponding to the cross section of the pipe section, whereby this throttle is mounted in a housing section so that due to the axial displacement of the cylindrical throttle element, the through-opening provided therein is more or less flush with the inside wall of the pipe so that the degree of opening of the throttle can be adjusted especially easily and accurately.

According to another embodiment of the inventive filter apparatus, it has a specially shaped throttle, whereby this throttle is characterized in that it completely avoids dead zones in the flow. To achieve this effect, the throttle has a conical receiving space, with a throttle element that also has a conical shape adapted thereto being arranged within this receiving space. The conical throttle element here is axially displaceable between the first position and the second position, a fluid feed partial channel arranged upstream from the throttle element being provided for the receiving space and a fluid discharge partial channel provided downstream from the throttle element also being provided for the receiving space. The stream of fluid enters the receiving space through the fluid feed partial channel and is removed from it the fluid discharge partial channel owing to the conicity of the receiving space and the throttle element, this design of the throttle permits a very fine adjustment of the degree of opening of the throttle, whereby at the same time the conical walls of the receiving space and the throttle prevent any unwanted deposits of fluid residues.

In particular when the fluid discharge partial channel in the embodiment of the inventive filter apparatus described above, having a special throttle, has a first section as seen in the direction of flow of the fluid, said section running outside of the receiving space on both sides of the housing and opening into the fluid discharge partial channel, the aforementioned advantages are achieved to a particularly great extent through a throttle having such a design.

In particular the first section of the fluid discharge partial channel, as seen in the direction of flow of the fluid, is designed as a ring channel, whereby the ring channel partially or completely surrounds the housing of the receiving space from the outside, as explained below on the basis of a concrete embodiment.

With regard to the embodiments of the inventive filter apparatuses described above, it should be pointed out that the fluid feed partial channel is preferably provided with the first connecting element and the fluid discharge partial channel is preferably then provided with the second connecting element.

To achieve the desired throttling of the fluid flow with the inventive filter apparatus, depending on the respective load on the filter, it is advisable for the throttle element of the embodiment described previously to be moved as a function of the actuating variable generated by the detection unit. This movement, which preferably represents an axial displacement of the throttle element, can be induced either manually or preferably automatically, with a drive being provided for the axial movement of the throttle element. This drive is designed as a hydraulic, pneumatic or electric drive in particular.

According to a refinement of the embodiment of the inventive filter apparatus described previously, the throttle element is moved over only a predetermined quantity and is preferably displaced axially. This predetermined quantity is between the first and second positions of the throttle element so that the degree of opening of the throttle is increased or decreased accordingly. When this predetermined variable is exceeded, a visual and/or an acoustic signal is generated so that occurrence of this signal indicates to the operating personnel that a filter change is necessary.

According to another variant of the embodiment of the inventive filter apparatus described previously, backwashing of a soiled filter is triggered automatically when the predetermined value is exceeded. However, this embodiment of the inventive filter apparatus requires at least two filters, whereby these two filters are movable optionally between a first position in which they both filter the fluid stream and a second position in which one filter is filtering the fluid stream while the other filter is being backwashed with a substream of filtered fluid in the opposite direction from the direction of flow in filtration. During this backwashing operation, the substream of filtered fluid dissolves the soiling that has collected on the filter surface and carries it away toward the atmosphere through a suitable valve upstream from the filter in the opposite direction from the direction of flow of the fluid in filtration so that after the end of this backwashing operation, a filter freed of dirt particles is made available again for renewed filtration.

Essentially the inventive filter apparatus may be designed in the known way; the belt filters described in the state of the art can be mentioned here as an example. However, it is especially suitable if the inventive filter apparatus is designed so that it has at least two filters arranged with an axial distance between them inside a bolt that is mounted in a housing and is axially displaceable thereto. Optionally the at least two filters may then have the fluid to be filtered flowing through them or the fluid to be filtered flows through at least one filter. While at the same time the at least one other filter is in a position outside of the housing, so that the one filter which is outside the housing can be replaced manually by the respective operating personnel and cleaned or exchanged and replaced by a new filter.

Another embodiment of the inventive filter apparatus which is also advantageous includes two bolts arranged inside a housing, displaceable axially thereto, each being provided with at least two filters arranged with an axial distance between them. These bolts are mounted in a fluid-tight and axially displaceable manner in corresponding housing bores, whereby optionally all filters have the fluid to be filtered flowing through them or at least one filter is in a position outside of the housing while the remaining other filters have the fluid to be filtered flowing through them. This achieves the result that one or more filters that are in a position outside the housing can be replaced and/or cleaned without interrupting the filtration process and without resulting in unwanted pressure fluctuations. Advantageous embodiments of the inventive method, the inventive apparatus and the inventive filter apparatus are characterized in the dependent claims.

The inventive method is explained in greater detail below on the basis of two exemplary embodiments in combination with the drawing, in which:

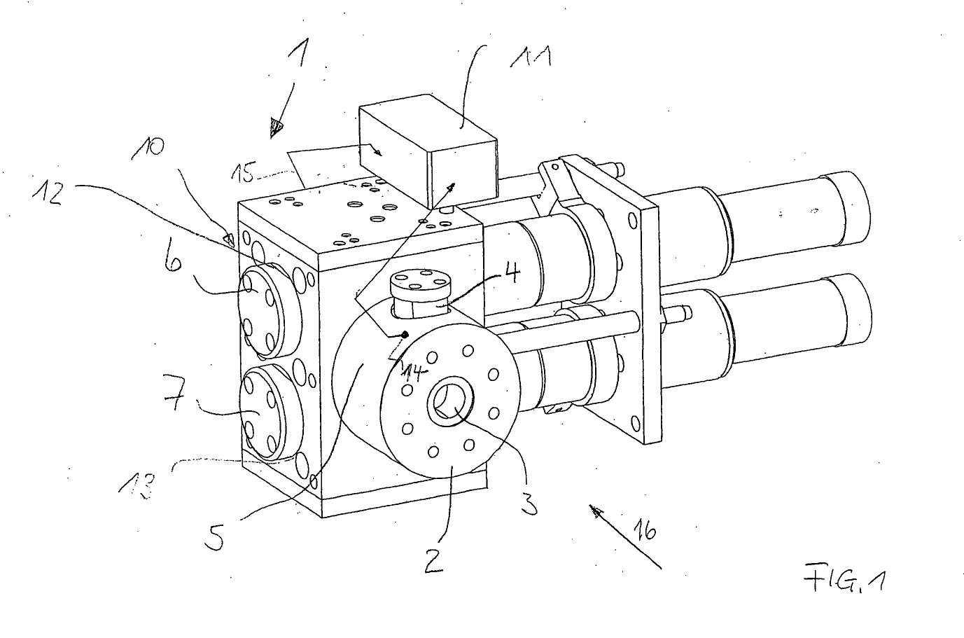

FIG. 1 shows a schematic perspective view of the inventive filter apparatus,

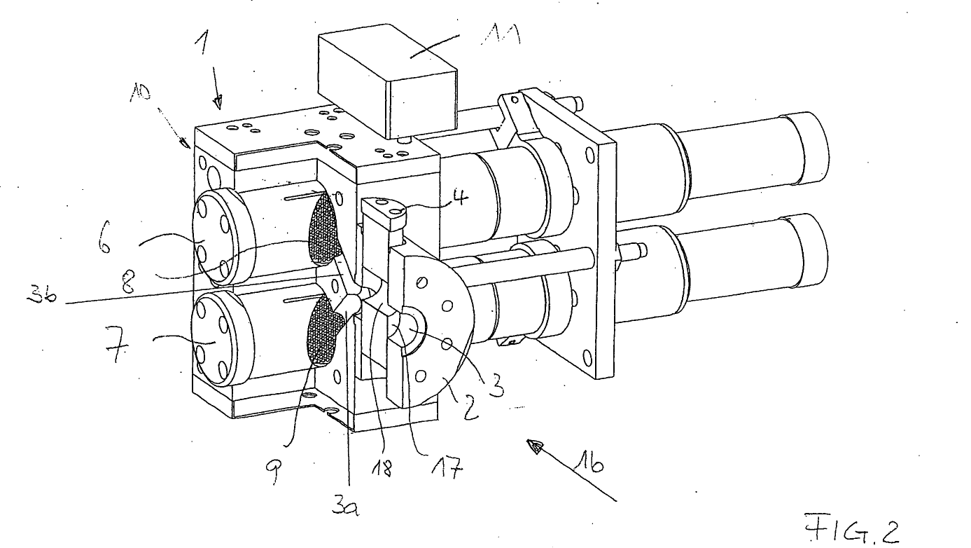

FIG. 2 like FIG. 1, but partially with a cutaway housing area,

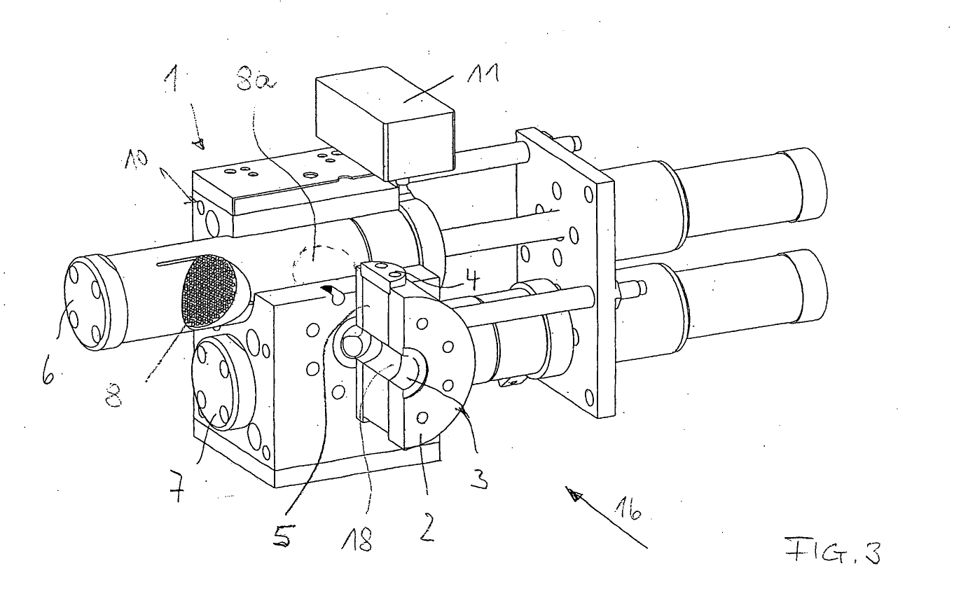

FIG. 3 like FIG. 1, but partially with a larger housing area with a cutaway in a different area,

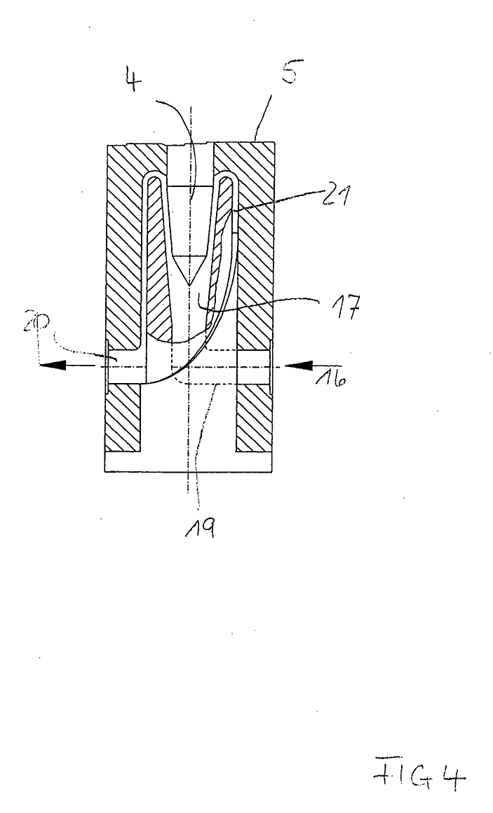

FIG. 4 a schematic sectional view of a throttle, the throttle element being illustrated in its second position (opened),

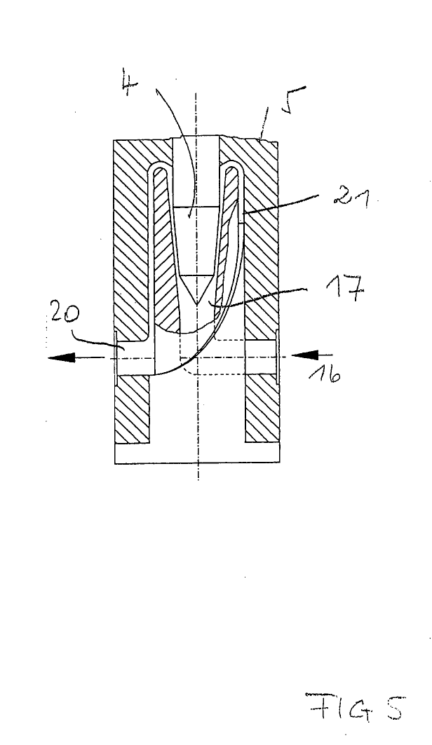

FIG. 5 like FIG. 4, but in a partially opened position of the throttle element, and

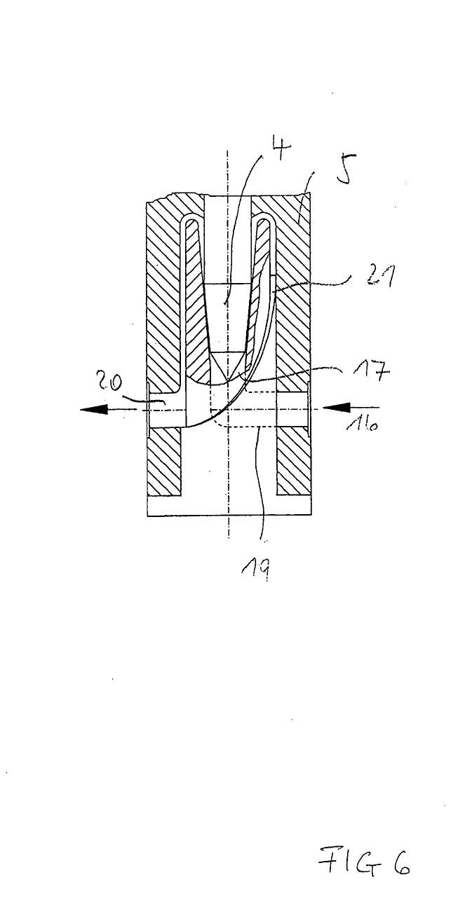

FIG. 6 like FIG. 4, but in a closed position of the throttle element.

FIGS. 1 through 6 show the same parts labeled with the same reference numerals.

The embodiment of the filter apparatus labeled as 1 on the whole in the illustration in FIGS. 1 through 3 has a fluid feed channel 3. This fluid feed channel 3 extends from a first connecting element 2 up to a first filter 8 or 8a and a second filter 9 or 9a (FIGS. 2 and 3). In addition, the filter apparatus 1 is equipped with a housing 10 which has two bores 12 and 13 arranged parallel to one another, supporting two bolts 6 and 7 that are aligned parallel to one another and are fluid-tight and axially displaceable. Each bolt is equipped with at least two filters 8 or 8a and 9 or 9a arranged with an axial distance between them, the second filter 8a and 9a being indicated only schematically as filter 8a in FIG. 3. A filter discharge channel (not shown) follows in the direction of flow 16 of the fluid to be filtered, whereby this fluid discharge channel is connected to a tool (not shown) via a second connecting element (not shown). Both the fluid feed channel and the fluid discharge channel have a channel division, as shown for the fluid feed channel 3 in FIG. 2, where it is labeled as 3a and 3b. This ensures that the filters 8, 8a, 9 and 9a are uniformly supplied with fluid to be filtered.

In addition, the filter apparatus 1 is provided with a detection unit 11 which is indicated only schematically in FIGS. 1 through 3. This detection unit 11 is provided with two pressure sensors 14 and 15, whereby the pressure sensor 14 is positioned upstream from the throttle 5 and the pressure sensor 15 is situated downstream from filters 8, 8a, 9 and 9a in the fluid discharge channel (not shown).

A throttle 5 provided in the fluid feed channel has a throttle element 4 which is axially displaceable in relation to the direction of flow of the fluid in the fluid feed channel, whereby FIGS. 2 and 3 reflect different positions of the throttle element 4. The receiving space 17 of the throttle element 4 is formed by a section of the fluid feed channel 3 in the embodiment of the throttle 5 shown in FIGS. 1 through 3.

As shown in FIGS. 2 and 3 in particular, the throttle element 4 is designed as a cylindrical throttle element having a through-opening 18 whose diameter is adapted to the inside cross section of the fluid feed channel 3 (FIGS. 2 and 3), so that the degree of opening of the throttle can be varied as desired by an axial displacement of the throttle element 4 in relation to the receiving space 17.

The filter apparatus 1 is connected by a first connecting element 2 to an extruder (not shown), for example, and is connected by the second connecting element to a tool (also not shown).

The filter apparatus mentioned above functions as described below.

First, the fluid to be filtered is supplied to the two filters 8 and 9 through the fluid feed channel 3 in the direction of the arrow 16, is filtered there and then is sent as filtered fluid through the following fluid discharge channel to the tool (not shown here). At this point in time, a pressure difference is measured by the two sensors 14 and 15, the size of this pressure difference being adjustable by means of the throttle 5. At the start of this filtration, the axially displaceable throttle element 4 of the throttle 5 is in a position like that illustrated in FIG. 2, for example, and referred to above as the first position of the throttle element 4, i.e., in this position the throttle almost completely interrupts the fluid flow because the overlap area between the through-opening 18 and the cross section of the fluid feed channel 3 amounts to only approximately 2% to 15% of the total cross section, preferably 5% to 10%.

Due to the throttling described above, a pressure of the fluid to be filtered is established at the sensor 14; this pressure has previously been referred to in general as the actual value of the working parameter of the fluid. In addition, another pressure is measured by the sensor 15, the pressure difference detected on the basis of these two pressures then being compared in the detection unit 11 with a predetermined pressure difference set value.

As soon as the available filters 8 and 9 (FIG. 2) have become soiled in the course of filtration, the actual value of the pressure difference changes, with the result that there is a deviation from the pressure difference set value, which in turn results in the detection unit 11 generating an actuating variable, so that the throttle element 4 is displaced axially downward, increasing the size of the total cross section. This reduces the backpressure produced by the throttle, where the measure of this reduction is directly proportional to the backpressure of the soiled filters 8 and 9. This process of continuous equalization and compensation of the backpressure of the soiled filter by the constant reduction in the backpressure of the throttle then results in a constant pressure in the system. However, as soon as the throttle element has reached a second position just before complete opening of the throttle element, an acoustic signal and/or a visual signal is generated, indicating that a filter change can be initiated. To do so, one of the two bolts moves into a position as illustrated in FIG. 3 in which the filter 8 is situated outside of the housing of the filter apparatus 1. At the same time, the throttle element 4 is shifted downward axially to such an extent that the through-opening 18 is aligned with the cross section of the fluid feed channel 3 over the full area and thus the throttle element does not interfere with the fluid flow; this is also referred to above as the second position. This coordinated axial displacement of the bolt and throttle element results in a constant pressure being maintained in the fluid flow.

After replacing the soiled filter 8, it is transferred back to a position in which it is arranged in the fluid stream, while at the same time the throttle element is displaced axially upward, resulting in an reduction in the degree of opening of the throttle. The extent of the axial displacement of the throttle element 4 here is controlled by the detection unit such that a constant pressure is established due to the comparison of the actual value of the pressure difference with the set value of the pressure difference, as already described several times.

By analogy, the filter 9 or the filters 8a and 9a (the latter are not shown) can be replaced; to replace the filters 8a and 9a, the bolts 8 and/or 9 are displaced axially to the right so far that they are positioned outside of the housing of the filter apparatus 1.

The throttle 5 also illustrated in FIGS. 4 through 6 differs from the throttle described previously in conjunction with FIGS. 1 through 3 in that the throttle according to FIGS. 4 through 6 is designed differently.

The throttle 5 illustrated in FIGS. 4 through 6 has a conically shaped throttle element 4 arranged inside a conically shaped receiving space 17. FIG. 4 shows the throttle element 4 in its maximum open position; FIG. 5 shows the throttle element 4 in its middle open position, and FIG. 6 shows the throttle element 4 in its closed position.

The fluid flows through the throttle 5 in the direction of flow 16. In this process, the throttle 5 has a fluid feed partial channel 19 which is situated upstream from the throttle element 4 and is connected at one end to the fluid feed channel 3 (not shown) and at the other end opens into the receiving space 17. Downstream from the throttle element 4, the fluid passes laterally by the throttle element between the outside wall of the conical throttle element 4 and the inside wall of the receiving space 17 when the throttle element is in the opened position, as illustrated in FIGS. 4 and 5, and then enters a fluid discharge partial channel 20, whereby a first section 21 of the fluid discharge partial channel is designed as an annular space. Due to the fact that the annular space is designed asymmetrically and has an area that tapers continuously, as indicated on the right side of FIGS. 4 through 6, the flow conditions in the annular space can be optimized due to such a throttle design, thereby preventing unwanted dead zones there.

The functioning of the throttle shown in FIGS. 4 through 6 corresponds to that of the throttle described above in conjunction with FIGS. 1 through 3.

If necessary, the throttle 5 described above in conjunction with FIGS. 4 through 6 may also have fluid flowing through it in the direction opposite the direction of the arrow 16 without altering the function of the throttle 5 described so far.

1. A method for filtering a fluid, in particular for filtering a polymer melt, in which a stream of fluid under pressure is passed continuously through at least one filter, and then the fluid filtered in this way is supplied to a tool, characterized in that the stream of fluid that is to be and/or has been filtered is throttled, that at least one actual value of a working parameter of the fluid is measured, that the actual value is compared with a predetermined set value, that at least one actuating variable is generated as a function of at least one deviation of actual value and the set value, and that the degree of throttling is varied as a function of this actuating variable.

2. The method for filtering a fluid, in particular for filtering a polymer melt, in which a stream of fluid under pressure is passed continuously through at least one filter, and then the fluid filtered in this way is supplied to a tool, characterized in that the stream of fluid that is to be and/or has been filtered is throttled, that at least one actual value of the degree of throttling is adjusted, that at least one actual value of a working parameter of the fluid is measured, and that the actual value of the degree of throttling is varied until the actual value of the working parameter of the fluid has a constant and predetermined set value, whereby the pressure, the flow quantity, the flow rate, the temperature and/or the viscosity of the fluid to be and/or has been filtered is measured as the actual value of the working parameter of the fluid.

3. The method according to claim 1, characterized in that the pressure, the flow quantity, the flow rate, the temperature and/or the viscosity of the fluid to be and/or has been filtered is measured as the actual value of the working parameter of the fluid.

4. The method according to claim 1, characterized in that the stream of fluid to be filtered is throttled.

5. The method according to claim 1, characterized in that the stream of fluid that has been filtered is throttled.

6. The method according to claim 1, characterized in that the pressure of the fluid to be filtered is measured, that when a predetermined pressure value is exceeded, the degree of throttling is reduced, and that when the pressure drops below a predetermined pressure level, the degree of throttling is increased.

7. The method according to claim 1, characterized in that the pressure of the fluid is measured upstream and downstream from the throttling, and that on reaching a limit value, a signal is generated for a filter change to be performed.

8. An apparatus for performing the method according to claim 1, whereby the apparatus has means, in particular an extruder, for producing a continuous stream of a fluid under pressure, in particular a polymer melt, and a filter device situated downstream thereof, having at least one filter for filtering the fluid and a tool situated downstream from that, characterized in that a detection unit (11, 14, 15) for the actual value of a working parameter of the fluid is provided for the area upstream and/or downstream from the filter device (1), that in addition a throttle (5) is provided in the stream of the fluid upstream and/or downstream from the filter device (1), and that the detection unit (11, 14, 15) generates an actuating variable for varying the degree of opening of the throttle (5) when there is a deviation between the actual value and a predetermined set value, such that the degree of opening of the throttle is increased continuously with an increase in the soiling of the at least one filter (8, 8a, 9).

9. The apparatus according to claim 8, characterized in that the detection unit is designed so that the detection unit (11, 14, 15) detects as the actual value of the working parameter of the fluid the pressure, the flow quantity, the flow rate, the temperature and/or the viscosity of the fluid.

10. The apparatus according to claim 9, characterized in that the detection unit (11, 14, 15) each has a pressure sensor (14, 15) for detecting the fluid pressure upstream and/or downstream from the filter device (1) or for detecting the pressure difference, that the actual pressure value thus detected and/or the actual pressure difference value is compared with the predetermined set pressure value and/or set pressure difference value, and that the degree of opening of the throttle (5) is increased as soon as the actual value of the pressure exceeds the set value of the pressure.

11. The apparatus according to claim 8, characterized in that the detection unit (11) each has a temperature sensor for detecting the fluid temperature upstream and/or downstream from the filter device (1) or for detecting a temperature difference, that the actual value of the temperature thus detected is compared with the predetermined set temperature, and that the degree of opening of the throttle (5) is increased as soon as the actual temperature exceeds the set temperature.

12. The apparatus according to claim 8, characterized in that the throttle (5) is situated upstream from the filter device (1).

13. The apparatus according to claim 12, characterized in that the throttle (5) is provided with a valve which, in its open position, discharges a fluid stream to the atmosphere.

14. The apparatus according to claim 8, characterized in that the throttle (5) is situated downstream from the filter device (1).

15. The apparatus according to claim 8, characterized in that the throttle (5) has a receiving space (17) through which the fluid flows for a throttle element (4) penetrating into the fluid, and that the throttle element is movable between a first position in which the fluid stream is almost interrupted and a second position in which the fluid stream is not reduced at all or virtually at all by the throttle element (4) and by vice versa.

16. The apparatus according to claim 15, characterized in that the throttle element (4) is designed as a cylindrical throttle plunger and the receiving space (17) is designed as a cylindrical receiving space, whereby the cylindrical throttle plunger is axially displaceable between the first position and the second position in the cylindrical receiving space.

17. The apparatus according to claim 8, characterized in that the receiving space (17) is designed as a conical receiving space and the throttle element (4) is designed as a conical throttle element, that the conical throttle element (4) is axially displaceable between the first position and the second position and that a fluid feed partial channel (19) arranged upstream from the throttle element (4) and a fluid discharge partial channel (19) situated downstream from the throttle element, which are both provided to the receiving space.

18. The apparatus according to claim 17, characterized in that the fluid discharge partial channel (20) has a first section (21) as seen in the direction of flow (16) of the fluid, said first section running on both sides of the housing of the receiving space (17) and opening into the fluid discharge partial channel (20).

19. The apparatus according to claim 18, characterized in that the first section (21) of the fluid discharge partial channel (20) is designed as a ring channel, whereby the ring channel partially or completely surrounds the housing of the receiving space (17).

20. The apparatus according to claim 8, characterized in that the throttle element (4) is moved as a function of the generated actuating variable.

21. The apparatus according to claim 20, characterized in that the throttle element (4) is moved over only a predetermined dimension, whereby this predetermined dimension is between the first and second positions of the throttle element (4) and when this predetermined dimension is exceeded, a visual and/or acoustic signal is generated.

22. The apparatus according to claim 20, characterized in that backwashing of the soiled filter (8, 8a, 9) is triggered automatically when the predetermined dimension is exceeded.

23. The apparatus according to claim 8, characterized in that the apparatus comprises a filter device (1) which has two filters (8, 8a, 9) arranged with an axial distance between them inside a bolt (6, 7) which is mounted in the housing (10) and is axially displaceable thereto, whereby optionally both filters (8, 9) have the fluid that is to be filtered flowing through them or one filter has the fluid that is to be filtered flowing through it while at the same time the other filter is in a position outside of the housing (10) of the filter device (1).

24. The apparatus according to claim 8, characterized in that the apparatus comprises a filter device (1) which has two bolts (6, 7) that are arranged with an axial distance between them inside a housing (10) and are axially displaceable thereto, whereby optionally the fluid that is to be filtered flows through all the filters, or at least one filter is in a position outside of the housing (10) of the filter device (1) while at the same time the fluid that is to be filtered is flowing through the other remaining filter.

25. A filter apparatus for performing the method according to claim 1, having a first connecting element (2) for connecting the filter apparatus (1) to a means for producing a continuous stream of a fluid under pressure and a second connecting element for connecting the filter apparatus (1) to a tool, whereby the filter apparatus (1) has at least one filter through which fluid flows, characterized in that a detection unit (11, 14, 15) for detecting the actual value of a working parameter of the fluid is situated between the first connecting element (2) and the filter (8, 8a, 9) and/or between the filter (8, 8a, 9) and the second connecting element, that in addition, a throttle (5) is provided in the stream of the fluid between the first connecting element (2) and the filter and/or between the filter and the second connecting element, and that the detection unit (11, 14, 15) generates an actuating variable for varying the degree of opening of the throttle (5) when there is a deviation between the actual value and the predetermined set such that the degree of opening of the throttle (5) is increased continuously with an increase in the soiling of the at least one filter (8, 8a, 9).

26. The filter apparatus according to claim 25, characterized in that the detection unit (11, 14, 15) is designed so that the detection unit (11, 14, 15) detects as the actual value of the working parameter of the fluid the pressure, the flow quantity, the flow rate, the temperature and/or the viscosity of the fluid.

27. The filter apparatus according to claim 26, characterized in that the detection unit (11, 14, 15) has a pressure sensor (14, 15) between the first connecting element (2) and the filter and/or between the filter and the second connecting element for detecting the fluid pressure upstream and/or downstream from the filter or for detecting the pressure difference, that the actual value of the pressure and/or the actual value of the pressure difference thus detected is compared with the predetermined set value of the pressure and/or set value of the pressure difference, and that the degree of opening of the throttle (5) is increased as soon as the actual value for the pressure exceeds the set value of the pressure.

28. The filter apparatus according to claim 25, characterized in that the detection unit (11, 14, 15) each has a temperature sensor between the first connecting element and the filter and/or between the filter and the second connecting element for detecting the fluid temperature upstream and/or downstream from the filter or for detecting a temperature difference, that the actual value of the temperature thus detected is compared with the predetermined set value of the temperature, and that the degree of opening of the throttle (5) is increased as soon as the actual value of the temperature exceeds the set value of the temperature.

29. The filter apparatus according to claim 25, characterized in that the throttle (5) is arranged between the first connecting element (2) and the filter (8, 8a, 9).

30. The filter apparatus according to claim 29, characterized in that the throttle (5) is provided with a valve which discharges a fluid stream to the atmosphere when it is in its opened position.

31. The filter apparatus according to claim 25, characterized in that the throttle (5) is arranged between the filter (8, 8a, 9) and the second connecting element.

32. The filter apparatus according to claim 25, characterized in that the throttle (5) has a receiving space (17) through which a fluid passes for receiving a throttle element (4) penetrating into the fluid, and that the throttle element (4) can be moved between a first position in which the fluid stream is almost interrupted and a second position in which the fluid stream is not hindered at all or is hindered very little by the throttle element (4) or vice versa.

33. The filter apparatus according to claim 32, characterized in that the throttle element (4) is designed as a cylindrical throttle plunger and the receiving space (17) is designed as a cylindrical receiving space whereby the cylindrical throttle plunger is axially displaceable between the first position and the second position in the cylindrical receiving space (17).

34. The filter apparatus according to claim 25, characterized in that the receiving space (17) is designed as a conical receiving space and the throttle element (4) is designed as a conical throttle element, that the conical throttle element is axially displaceable between the first position and the second position; and that the receiving space (17) is assigned a fluid feed partial channel (19) upstream from the throttle element (4) and a fluid discharge partial channel (20) downstream from the throttle element (4).

35. The filter apparatus according to claim 34, characterized in that the fluid discharge partial channel (20) has a first section (21) as seen in the direction of flow (16) of the fluid, said section running on both sides of the housing of the receiving space (17) and opening into the fluid discharge partial channel (20).

36. The filter apparatus according to claim 35, characterized in that the first section (21) of the fluid discharge partial channel (20) is designed as a ring channel, whereby the ring channel partially or completely surrounds the housing of the receiving space (17).

37. The filter apparatus according to claim 25, characterized in that the throttle element (4) is moved as a function of the generated actuating variable.

38. The filter apparatus according to claim 37, characterized in that the throttle element (4) is moved over only a predetermined dimension, whereby this predetermined dimension is between the first and second positions of the throttle element (4), and that when this predetermined dimension is exceeded, a visual and/or an acoustic signal is generated.

39. The filter apparatus according to claim 37, characterized in that backwashing of a soiled filter is automatically triggered when the predetermined dimension is exceeded.

40. The filter apparatus according to claim 25, characterized in that the filter apparatus (1) has a bolt (6, 7) which is mounted inside a housing (10) and is axially displaceable thereto, said bolt being provided with two filters (8, 8a, 9) arranged with an axial distance between them whereby optionally the two filters have the fluid that is to be filtered flowing through them or one filter has the fluid that is to be filtered flowing through it while at the same time the other filter is in a position outside of the housing (10) of the filter apparatus (1).

41. The filter apparatus according to claim 25, characterized in that the filter apparatus (1) has at least two bolts (6, 7) arranged inside a housing (10) being axially displaceable thereto, each being provided with at least two filters (8, 8a, 9) arranged with an axial distance between them, whereby optionally all filters have the fluid that is to be filtered flowing through them or at least one filter is in a position outside of the housing (10) of the filter apparatus (1) while at the same the other remaining filter has the fluid that is to be filtered flowing through it.
